(19) United States
(12) Patent Application Publication
(10) Pub. No.: US 2026/0241794 A1
(43) Pub. Date: Aug. 20, 2026

(54) SPATIAL CONTEXT AUDIO SYSTEM FOR A VEHICLE

(71) Applicant: NISSAN NORTH AMERICA, INC., Franklin, TN (US)

(72) Inventors: Niloofar ZAREI, Campbell, CA (US); Stefan WITWICKI, San Carlos, CA (US); Erik ST. GRAY, Tacoma, WA (US)

(21) Appl. No.: 19/057,667

(22) Filed: Feb. 19, 2025

(51) Int. Cl. B60K 35/26; G06V 20/58; H04S 7/00

(52) U.S. Cl. CPC B60K 35/26; G06V 20/58; H04S 7/00

(57) ABSTRACT

An audio system for a host vehicle includes a plurality of sensors, a infotainment system, and an electronic controller. The plurality of sensors are configured to detect information regarding objects in an area surrounding the host vehicle. The infotainment system includes a first speaker and a second speaker. The electronic controller is configured to play a note through the infotainment system based on the information detected by the plurality of sensors.

### BACKGROUND

### Technical Field

The present disclosure generally relates to a spatial context audio system for a vehicle. More specifically, the present disclosure relates to an audio system for a vehicle in which music is played based on the vehicle surroundings.

### Background Information

Conventional audio systems for vehicles are configured to allow a vehicle occupant to enjoy music while traveling in vehicles. Listening to music while traveling can alleviate stress and improve focus and mood of the vehicle occupant.

One conventional audio system for a vehicle adapts music being played based on an annotated vehicle trajectory. The music being played can be updated based on an upcoming highway entrance or exit that is annotated on a current global positioning system (GPS) trajectory. A high-contrast event in the music, such as a song transition or a beat drop, can be played based on the annotated GPS trajectory. This conventional system does not take into account the surroundings of the vehicle to update the music being played.

Another conventional audio system for a vehicle adapts music being played based on an action of a driver. The action of the driver is converted into a musical expression, such as a change in the sound, panning, and/or volume. This conventional system can incentivize a driver to operate the vehicle in an unsafe manner, such as accelerating, to influence the music being played.

### SUMMARY

A need exists for an improved audio system for a vehicle in which music is played based on the vehicle surroundings.

In view of the state of the known technology, one aspect of the present disclosure is to provide an audio system for a host vehicle including a plurality of sensors, an infotainment system, and an electronic controller. The plurality of sensors are configured to detect information regarding objects in an area surrounding the host vehicle. The infotainment system includes a first speaker and a second speaker. The electronic controller is configured to play a note through the infotainment system based on the information detected by the plurality of sensors.

Another aspect of the present invention is to provide an audio system for a host vehicle including a plurality of sensors, a memory, an infotainment system, and an electronic controller. The plurality of sensors is configured to detect information regarding objects in an area surrounding the host vehicle. The memory is configured to store a plurality of tracks and a plurality of notes. The infotainment system includes a first speaker and a second speaker. The electronic controller is configured to play one track of the plurality of tracks continuously through the infotainment system during operation of the host vehicle and configured to play one note of the plurality of notes through the infotainment system based on the information detected by the plurality of sensors. The one note is played on top of the one track.

Also other objects, features, aspects and advantages of the disclosed spatial context audio system for a vehicle will become apparent to those skilled in the art from the following detailed description, which, taken in conjunction with the annexed drawings, discloses exemplary embodiments of the spatial context audio system for a vehicle.

### BRIEF DESCRIPTION OF THE DRAWINGS

Referring now to the attached drawings which form a part of this original disclosure:

FIG. 1 is a schematic diagram illustrating components of the audio system of a host vehicle in accordance with an exemplary embodiment;

FIG. 2 is a schematic diagram of a communication system of the host vehicle equipped with the audio system of FIG. 1;

FIG. 3 is a schematic diagram of the audio system of the host vehicle of FIG. 1.

FIG. 4 is an illustration of the host vehicle of FIG. 1 acquiring information in an area surrounding the host vehicle;

FIG. 5 is another illustration of the host vehicle of FIG. 1 acquiring information in an area surrounding the host vehicle; and

FIG. 6 is an exemplary view of a graphical user interface of the audio system of FIG. 3.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

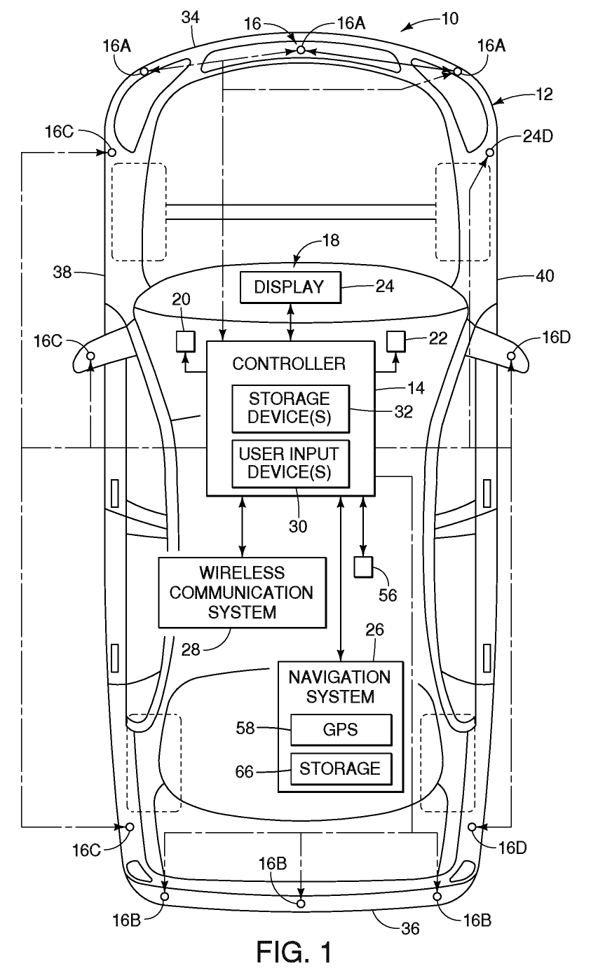

An audio system 10 for a host vehicle 12 in accordance with an exemplary embodiment is shown in FIG. 1. The audio system 10 includes an electronic controller 14, a plurality of sensors 16, and an infotainment system 18. The plurality of sensors 16 is configured to detect information regarding objects in an area surrounding the vehicle 12. The infotainment system 18 includes a first speaker 20 and a second speaker 22. The first speaker 18 is preferably disposed on a left, or driver, side of the host vehicle 12, and the second speaker 20 is preferably disposed on the right, or passenger, side of the host vehicle 12. The infotainment system 18 can include additional speakers throughout the host vehicle 12. The electronic controller 14 is configured to play a note through the infotainment system 18 based on the information detected by the plurality of sensors 16.

The electronic controller 14 preferably includes a microcomputer with a control program that controls the components of the audio system 10 as discussed below. The electronic controller 14 includes other conventional components, such as an input interface circuit, an output interface circuit, and storage device(s), such as a ROM (Read Only Memory) device and a RAM (Random Access Memory) device. The microcomputer of the electronic controller 14 is at least programmed to control the audio system 10 in accordance with the following description. The microcomputer of the electronic controller 14 is programmed to control the plurality of sensors 16, a display 24, a navigation system 26, and a wireless communication system 28, and to make determinations or decisions, as discussed herein. The memory circuit stores processing results and control programs, such as ones for the plurality of sensors 16, the display 24, the navigation system 26, and the wireless communication system 28. The electronic controller 14 is operatively coupled to the plurality of sensors 16, the display 24, the navigation system 26, and the wireless communication system 28 in a conventional manner, as well as other electrical systems in the host vehicle 12, such the turn signals, windshield wipers, lights and any other suitable systems. Such a connection enables the electronic controller 14 to monitor and control any of these systems as desired. The internal RAM of the electronic controller 14 stores statuses of operational flags and various control data. The internal ROM of the electronic controller 14 stores the information for various operations. The electronic controller 14 is capable of selectively controlling any of the components of the audio system 10 in accordance with the control program. It will be apparent to those skilled in the art from this disclosure that the precise structure and algorithms for the electronic controller 14 can be any combination of hardware and software that will carry out the functions of the exemplary embodiments of the present invention. Furthermore, the electronic controller 14 can communicate with the other components of the vehicle communication system discussed herein via, for example a controller area network (CAN) bus or in any other suitable manner as understood in the art.

The electronic controller 14 can include or be in communication with user input devices 30. The user input devices 30 can include, for example, a human-machine interface (HMI), such as a control panel or a touchscreen graphical user interface (GUI), which enables a user (e.g., the driver and/or passenger) to interact with the audio system 10 as understood in the art and discussed herein. The user input device 30 can be incorporated with the display 24 to facilitate interaction by a user. The electronic controller 14 can further include or be in communication with one or more storage devices 32, such as a vehicle memory, that can store information as described herein.

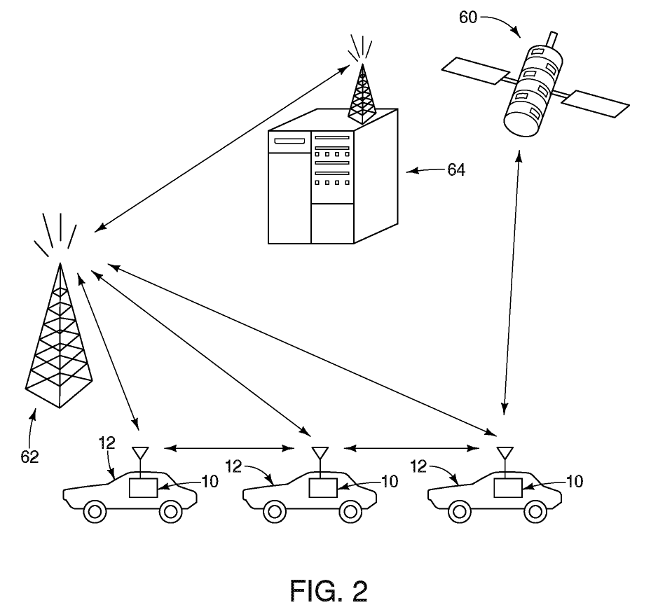

A two-way wireless communications network is illustrated that includes vehicle to vehicle communication and vehicle to base station communication, as shown in FIG. 2. A plurality of host vehicles 12 are illustrated, each of which is equipped with the audio system 10.

The audio system 10 of each host vehicle 12 communicates with the two-way wireless communications network. As shown in FIG. 2, for example, the two-way wireless communications network can include one or more global positioning satellites 60 (only one shown), and one or more roadside (terrestrial) units 62 (only one shown), and the base station or external server 64. The global positioning satellites 60 and the roadside units 62 send and receive signals to and from the audio system 10 regarding detected objects. The server 64 sends and receives signals to and from the audio system 10 via a network of the roadside units 62, or any other suitable two-way wireless communications network.

As shown in FIG. 1, the host vehicle 12 is equipped with the plurality of sensors 16 that can generate or capture vehicle environment information. In other words, the plurality of sensors 16 are configured to detect information regarding objects in the area surrounding the host vehicle 12. Additional information can be obtained from other vehicles through the two-way wireless communication network, as shown in FIG. 2. Four sensors 16A, 16B, 16C and 16D are provided, although any suitable number of sensors can be used. The plurality of sensors 16 include a front sensor 16A, a rear sensor 16B, a first, or driver’s, side sensor 16C and a second, or passenger’s, side sensor 16D. The front sensor 16A is preferably centrally located on a front bumper 34 of the vehicle 12. Additional front sensors 16A can be disposed on opposite ends of the front bumper 34. The rear sensor 16B is preferably centrally located on the rear bumper 36. Additional rear sensors 16B can be disposed on opposite ends of the rear bumper 36. The first side sensor 16C and the second side sensor 16D are disposed on the respective sides 38 and 40 of the vehicle 12, such as on an exterior side mirror or proximate a lower surface of the vehicle body structure beneath a door. Additional first and second side sensors 16C and 16D can be spaced along the respective sides 38 and 40 of the vehicle 12. Although the exemplary embodiments of the present invention can be practiced with a single sensor 16, providing a sensor on additional sides of the vehicle 12 allows information regarding objects in an area surrounding the host vehicle 12 to be obtained from any side of the vehicle 12. Additional sensors 16 on each side of the vehicle increase the accuracy and coverage of obtaining curb management information.

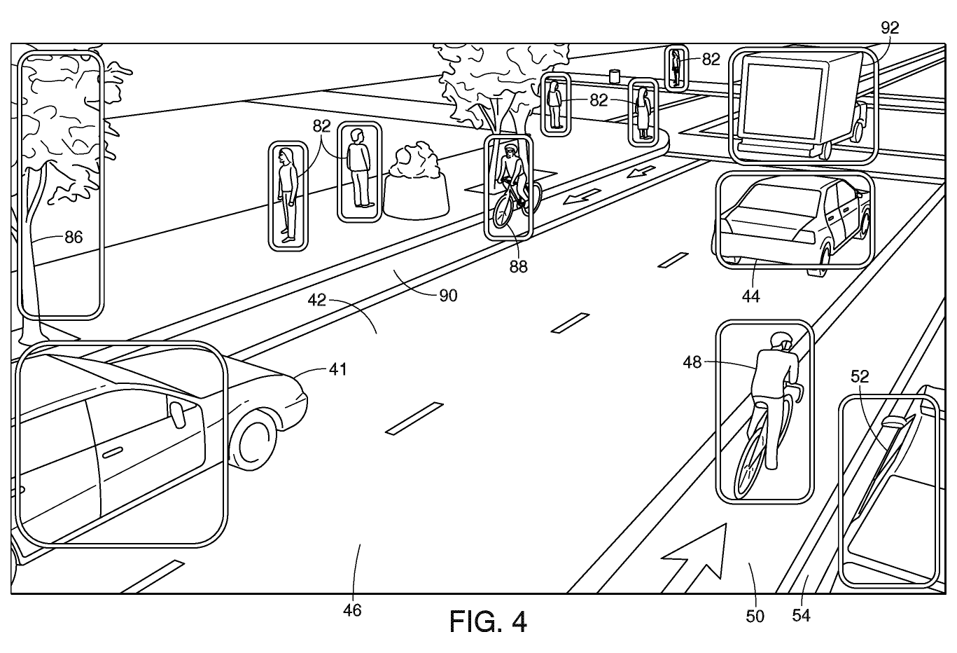

The plurality of sensors 16 can be any of a plurality of differing types of sensors, often referred to as detection and ranging sensors or devices. The plurality of sensors 16 can be, but is not limited to, a depth camera, an ultrasonic sensor, a light detection and ranging (LiDAR) sensor, or a camera. Specifically, the plurality of sensors 16 includes an emitting section (not shown) and a detecting section (not shown). The emitting section emits a prescribed signal and the detecting section detects returning signals that are reflected back from surfaces of nearby objects. Detection and ranging sensors are conventional devices, such that further description is omitted for the sake of brevity. The distance between the detected object, such as a first vehicle 41 in an adjacent lane 42, a second vehicle 44 in the same lane 46 as the host vehicle 12, a first bicyclist 48 in a bicycle lane 50, or a parked vehicle 52 in a curbside parking space 54 (FIG. 4) and the host vehicle 12 is determined by the electronic controller 14 using object information detected by the plurality of sensors 16.

The plurality of sensors 16 is provided such that a distance between an object and the host vehicle 12 on which the plurality of sensors 16 is disposed can be detected. Preferably, at least one sensor 16 is disposed at each of the sides 38 and 40 of the vehicle 12 to detect a distance between an object and a side of the host vehicle 12. As shown in FIG. 1, the host vehicle 12 can be provided with at least one sensor 16 on each of the four sides of the host vehicle 12 such that a distance between the vehicle and an object can be detected with respect to any side of the vehicle 12. The front sensor 16A, the rear sensor 16B, the first side sensor 16C, and the second side sensor 16D are sensors configured to detect the presence of the object and to measure and/or determine the distance between the detected object and the respective adjacent outer surface of the vehicle body structure as the vehicle body structure approaches the detected object. Each of the plurality of sensors 16 is configured to detect the distance between an object and the approaching respective outer surface of the vehicle 12 within a predetermined tolerance of, for example, plus-or-minus one inch (less than three centimeters). However, it should be understood that the tolerances can be greater or can be less, depending upon the size of the vehicle 12 and the specific type of sensor employed.

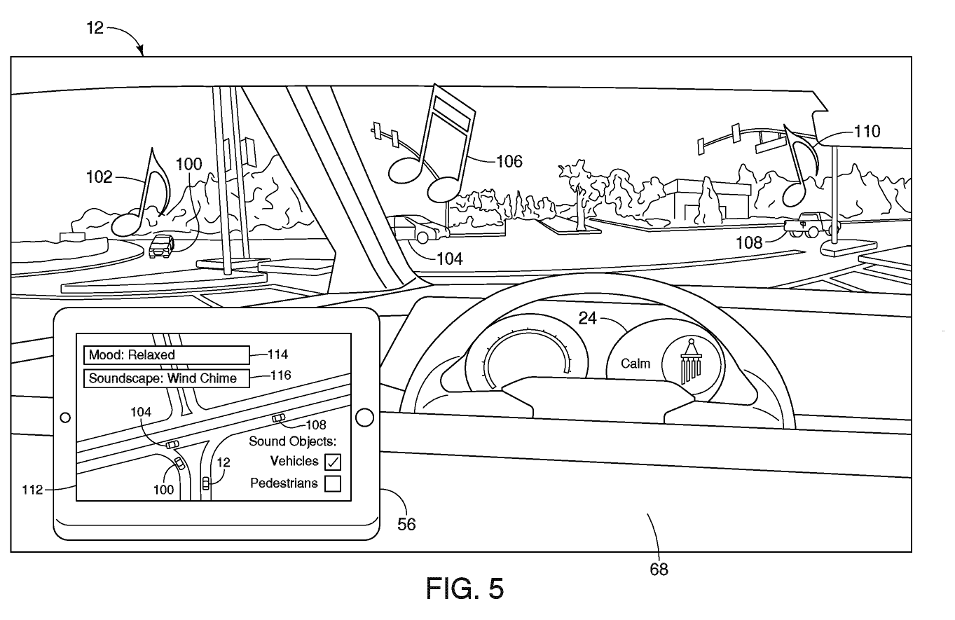

The display 28 of the infotainment system 18 displays, for example, navigation information that indicates the location of the host vehicle 12 with respect to a map, as understood in the art. The display 28 can also display information related to operation of the audio system 10 and allow a user to interact with the audio system 10 as described below. The display 28 can incorporate the user input device 30, such as through a touchscreen, thereby allowing a user to interact with the audio system 10. The infotainment system 18 can further include a rear seat display 56, as shown in FIG. 5.

The audio system 10 of the host vehicle 12 can further include the vehicle navigation system 26, as shown in FIG. 1. The vehicle navigation system 26 includes, for example, a communication device 58, such as a GPS (Global Positioning System) communication device, that communicates with the GPS satellites 60 (FIG. 2). The communication device 58 can also communicate with one or more terrestrial units 62 and the base station or external server 64 to obtain location information and to communicate and receive audio system information. Furthermore, the vehicle navigation system 26 can include or is in communication with a storage device 66 that can store vehicle information, such as previous vehicle route information, location information, or other vehicle information that the GPS is capable of generating, in addition to map data and other location related data as understood in the art. The vehicle navigation system 26 can receive vehicle data from any suitable source, such as a remote device capable of connecting with the navigation system 26.

The audio system 10 of the host vehicle 12 can further include the wireless communication system, or telematics control unit (TCU), 28. The wireless communication system 28 is a communication transceiver for performing a wireless communication with an external wireless communication device, such as a mobile device used within a passenger compartment 68 of the host vehicle 12, as is understood in the art. The wireless communication system 28 can be configured for short-range wireless communication, such as Bluetooth, and/or for communication over a wireless network.

The audio system 10, in accordance with exemplary embodiments, provides a unique audio experience for each drive that is based on the surroundings of the host vehicle 12. In other words, the audio system 10 generates a unique soundscape for each drive based on the surroundings of the host vehicle 12. The plurality of sensors 16 detect information regarding objects in an area surrounding the host vehicle 12 such that pre-processing of a map generated for the route to be traveled is not required nor is the generated soundscape based on an action of a driver of the host vehicle 12, thereby resulting in increased safety of operation of the host vehicle 12.

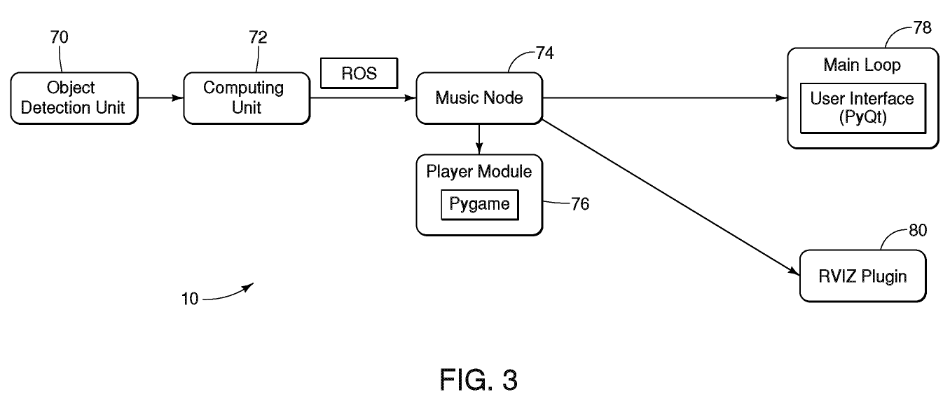

As shown in FIG. 3, the audio system 10 of the host vehicle 12 includes an object detection unit 70, a computing unit 72, a music node 74, and a player module 76, which are stored in the storage device 32 of the electronic controller. The audio system 10 can further include a user interface 78 that allows a user to interact with the music node. The audio system 10 can further include a plug-in module 80 that indicates a detected object determined to be a composer in a world model view, such as on the rear seat display 56 (FIG. 5).

As shown in FIG. 3, the object detection unit 70, such as Mobileye, detects objects in the area surrounding the vehicle with the plurality of sensor 16. As shown in FIG. 4, the object detection unit 70 detects objects in the area surrounding the host vehicle 12. The detected objects include, but are not limited to, other vehicles, bicycles, pedestrians, and trees, as shown in FIG. 4.

The computing unit 72 is configured to determine object data regarding the detected objects, as shown in FIG. 3. The detection unit 70 transmits information regarding the detected objects to the computing unit 72. The information transmitted by the detection unit 70 is based on the information detected by the plurality of sensors 16. The computing unit 72 can use any suitable method to determine the object data, such as using world model processing. The computing unit 72 determines object data, which includes, but is not limited to, a speed and a position of the detected object. As shown in FIGS. 4 and 5, the speed and the position of each object detected by the detection unit 70 is determined by the computing unit 72.

The object data determined by the computing unit 72 is transmitted to the music node 74, as shown in FIG. 3. The object data can be transmitted through a robot operating system (ROS) to facilitate decision making by the music node 74. The music node 74 is configured to determine a composer based on predetermined system parameters. A composer is defined as a detected object resulting in generation of a note to be played through the infotainment system 18. The music node 74 uses multi-threading for efficiency, such that a plurality of detected objects can be continuously processed simultaneously. A composer identification is assigned to each detected object determined to be a composer, and published over ROS to a player module 76, such that unique notes can be assigned and played for each detected object determined to be a composer.

The music node 74 transmits a signal to the player module 76 configured to play a note associated with the detected object determined to be a composer, as shown in FIG. 3. The player module 76 can be developed using any suitable module, such as Pygame. In other words, when a detected object is determined to be a priority by the music node 74, the detected object is determined to be a composer, thereby resulting in a signal to be transmitted to the player module 76 to play a note corresponding to the detected object. The transmission to the player module 76 is preferably asynchronous such that the player module 76 can play a note for a composer without waiting for a response from the music node 74. The player module 76 receives all the parameters necessary from the transmission from the music node 74 to enable the player module 76 to play the note associated with the composer. The received parameters include, but are not limited to, the host vehicle speed to adjust the volume of the background track, the field of view information for stereo setting of composers, and which notes to play for which composer.

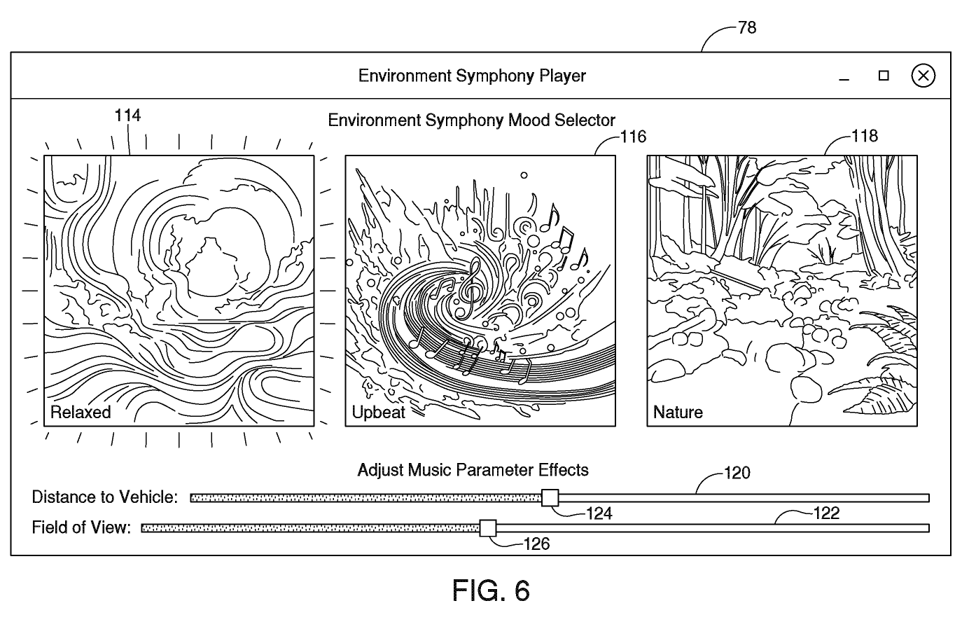

A graphical user interface (GUI), or interface, 78 allows a user to interact with the music node 74, as shown in FIG. 3. The interface 78 can be developed using any suitable framework, such as PyQt. The interface 78 allows the user to adjust system parameters, and to set a mood selection. The interface 78 can be used to adjust a size of the area, i.e., the field of view, surrounding the host vehicle 12 or the distance over which an object can be detected, as shown in FIG. 6. An area surrounding the host vehicle 12 is shown in FIGS. 4 and 5. The size of the area can be increased or decreased by the user through the interface 78, as shown in FIG. 6. The distance over which an object can be detected can be increased or decreased by the suer through the interface 78, as shown in FIG. 6.

A plug-in module 80, such as an RViz (ROS visualization) plug-in, receives a signal from the music node 74 that causes information to be displayed on a device, such as the display 24 or the rear-seat display 56 of the infotainment system 18.

As shown in FIG. 4, the plurality of sensors 16 detect objects in the area surrounding the host vehicle 12. The information obtained by the plurality of sensors 16 is transmitted to the object detection unit 70 (FIG. 3) to identify the objects in the area surrounding the vehicle 12 based on the information obtained by the plurality of sensors 16. As shown in FIG. 4, the detected objects include, but are not limited to, other vehicles, bicycles, pedestrians, and trees. Based on the information obtained by the plurality of sensors 16, the object detection unit 70 identifies the first remote vehicle 41 in the adjacent lane 52 to the lane 46 in which the host vehicle 12 is currently traveling, and the second remote vehicle 44 in the same lane 46 and ahead of the host vehicle 12. The object detection unit 70 further identifies the parked vehicle 52 in the curbside parking space 54. The object detection unit 70 further identifies the first bicyclist 48 traveling in the first bicycle lane 50 traveling the same direction as the host vehicle 12. The object detection unit 70 further identifies a plurality of pedestrians 82 on the sidewalk 84 to the left of the host vehicle 12. The object detection unit further identifies a tree 86 located on the sidewalk 84 to the left of the host vehicle 12. The object detection unit further identifies a second bicyclist 88 in a second bicycling lane 90 traveling in an opposite direction as the host vehicle 12. The object detection unit 92 further identifies a third remote vehicle 92 traveling in the adjacent lane 42 and ahead of the first remote vehicle 41. The information regarding the detected objects is transmitted to the computing unit 72.

The computing unit 72 is configured to determine the object data regarding the plurality of detected objects identified by the object detection unit 70, as shown in FIG. 3. The computing unit 72 determines the object data for each of the plurality of detected objects, which includes, but is not limited to, the speed and the position of the detected object. As shown in FIGS. 4 and 5, the speed and the position of each object detected by the detection unit 70 is determined by the computing unit 72. The object data for each of the plurality of detected objects is transmitted to the music node 74.

The music node 74 is configured to determine whether each of the detected objects is a composer based on predetermined system parameters, as shown in FIG. 3. Upon determining that a detected object is a composer, a note is caused to be played through the infotainment system 18.

The system parameters used to determine whether a detected object is a composer include, but are not limited to, a type of object to be detected, a position of the detected object in the driver’s visual field, a distance from the host vehicle 12 to the detected object, a velocity of the detected object relative to the host vehicle 12, the absolute velocity of the detected object, and the time that the detected object has remained in the composer list. The information for each parameter is obtained by the plurality of sensors 16, except for the amount of time that the detected object has remained in the composer list, which is determined by the music node 74. Each parameter can be weighted equally or assigned a weight, which can be set and adjusted through the user interface 78 to allow for customization of the parameters. The music node 74 can be set such that objects detected having an absolute velocity of zero (i.e., a non-moving object) are ignored, such as the tree 86 on the sidewalk 84 of FIG. 4. The position of the detected object in the driver’s visual field parameter and the distance from the host vehicle 12 to the detected object parameter can be prioritized to have a greater weight, as these parameters are indicative of a higher risk to the host vehicle 12. The higher priority objects are selected are determined to be a composer, and the lower priority objects are determined to not be a composer. A score can be assigned based on each of the parameters, and a total score determined for each of the detected objected. Upon determining that the total score for the detected object is equal to or above a predetermined threshold, the detected object is determined to be a composer. Upon determining that the total score for the detected object is below the predetermined threshold, the detected object is determined to not be a composer. Any other suitable method can be used to determine whether the detected object is a composer using the system parameters.

As shown in FIG. 4, four objects are determined by the music node 74 to be composers. The first remote vehicle 41, the second remote vehicle 44, the third remote vehicle 92, and the first bicyclist 48 are determined to be composers, such that a different note is caused to be played corresponding to each of the composers. In other words, a different note is played corresponding to each of the detected objects determined to be a composer. Each of the plurality of detected objects determined to be a composer is assigned note to be played indicative of the score for the detected object. The pedestrians 82 detected on the sidewalk 84, the tree 86 on the sidewalk 84, the second bicyclist 88, and the parked car 52 are determined to be low risk and are determined to not be composers. A note is not caused to be played for a detected object that is not determined to be a composer. The note assigned to each of the four detected objects are different, and are preferably assigned from a low note to a high note to generate a more coordinated soundscape. The higher priority composer can be assigned the lowest note, and each subsequent priority composer can be assigned a higher note.

During travel of the host vehicle 12, a background track is played continuously. In other words, the audio system 10 is configured to play the track continuously during operation of the host vehicle 12. The track can play in a loop to provide continuous play of the track. The volume of the track can correspond to the speed of the host vehicle 12. When the host vehicle 12 travels at a slower speed, the track plays at a lower volume, and at a higher speed, the track plays at a louder volume. In other words, the volume of the track is adaptive to the speed of the host vehicle 12. The note that corresponds to each of the composers is played on top of the background track.

The note that is played can be indicative of the type of object detected. A first note can be played that corresponds to a detected vehicle, such as the first and second remote vehicles 41 and 44. A second note can be played that corresponds to a detected bicyclist, such as the bicyclist 48. A third note can be played that corresponds to a detected pedestrian. The first note is a different note from the second note, which is a different note from the third note. When a note is played because an object is identified, the vehicle occupant can determine the type of object based on the note played.

The available notes to be played can be selected from one of three octaves, although more octaves can be used. The notes of each octave can correspond to a different type of object. For example, notes of a lowest octave can be used when the detected object is determined to be a truck. Notes of a middle object can be used when the detected object is determined to be a sedan. Notes of a highest octave can be used when the detected object is determined to be a sport utility vehicle (SUV). Additional octaves can used when the detected object is determined to be a pedestrian or a bicyclist. As shown in FIG. 5, the type of object to be detected can be a parameter selected by the user.

The note played for a composer can be based on a position of the corresponding detected object in the field of view of the vehicle driver. The information obtained by the plurality of sensors 16 includes a location of the detected object relative to the host vehicle 12. As shown in FIG. 4, the note played for the first remote vehicle 41, which is determined to be a composer, is left-balanced. The note played for the first bicyclist 48, which is determined to be a composer, is right-balanced. The note played for the second remote vehicle 44, which is ahead of the host vehicle 12 in the same lane 46, is center-balanced. In other words, the note is played louder in the first speaker 20 or the second speaker 22, or played equally loudly by the first and second speakers 20 and 22, based on the location of the detected object. The stereo sound playback allows the driver to determine the location of the detected object based on the played note.

The note played for a composer can be based on a distance of the detected object relative to the host vehicle 12. The information obtained by the plurality of sensors 16 includes a distance of the detected object relative to the host vehicle 12. The note is played louder for composers closer to the host vehicle 12. In other words, the louder the note played, the closer the detected object corresponding to the composer is to the host vehicle 12. As shown in FIG. 4, the note played for the second remote vehicle 44 is louder than the note played for the third remote vehicle 92 because the second remote vehicle 44 is closer to the host vehicle 12 than the third remote vehicle 92. The note played for the first remote vehicle 41 is louder than the note played for the second remote vehicle 44 because the first remote vehicle 41 is closer to the host vehicle 12 than the second remote vehicle 44. In other words, the volume of the note is indicative of the distance to the detected object.

The played notes act as an improved blind spot alert as the played notes create a spatial awareness through the coordinated soundscape that is generated. The generated notes are spatially oriented toward the detected object that causes that note to be generated. The note played increases in volume the closer the detected object is to the host vehicle 12. The note played is also directionally balanced to inform the driver of the positional relationship of the detected object relative to the host vehicle 12.

The system illustrated in FIG. 3 continuously processes detected objects during travel of the host vehicle 12. When a detected object is determined to be a composer, the note that is associated with the composer continues to be played until the detected object receives a score lower than the predetermined threshold. When the host vehicle 12 passes the first bicyclist 48 in FIG. 4, the first bicyclist 48 is no longer detected, the first bicyclist 48 is determined to not be a composer, and the associated note stops being played. When a new detected object is determined to be a composer, the new detected object is added to the composer list and a new note is played over the track in addition to the notes corresponding to the other composers.

As shown in FIG. 5, three objects are determined by the music node 74 to be composers. A fourth remote vehicle 100 is determined to be a composer, and a note 102 is played indicative of the fourth remote vehicle 100. A fifth remote vehicle 104 is determined to be a composer, and a note 106 is played indicative of the fifth remote vehicle 104. A sixth remote vehicle 108 is determined to be a composer, and a note 110 is played indicative of the sixth remote vehicle 110. The first, second and third notes 102, 106 and 110 are different from one another, and convey information regarding each of the detected objects, such as, but not limited to, distance from the host vehicle 12 and position relative to the host vehicle 12.

The RViz plug-in 80 displays a world model view 112 on the rear seat display 56 disposed in the passenger cabin 68 of the host vehicle 12, as shown in FIG. 5. The world model view can also be displayed on the display 24 of the infotainment system 18. The world model view 112 includes a representation of the host vehicle 12, and the fourth, fifth and sixth remote vehicles 100, 104 and 108. The world model view 112 also allows noted for composers corresponding to vehicles and pedestrians to be toggled on or off. As shown in FIG. 5, the sound for detected objects that are vehicles determined to be composers is on, the sound for detected objects that are pedestrians determined to be composers is turned off. Although the categories for sound are shown as being vehicles and pedestrians, the categories are not limited thereto and can include other categories, such as bicyclists.

The rear seat display 56 further includes an indication of the type of background track being played, and the music associated therewith. As shown in FIG. 5, the selected background is indicated in a first window 114, and the soundscape associated therewith is indicated in a second window 116. As shown in FIG. 5, the selected mood music for the background track is shown in the first window as relaxed. The selected soundscape for the selected relaxed mood is wind chime, which is shown in the second window 116.

An exemplary graphical user interface 78 is shown in FIG. 6. The interface 78 can be displayed on the display 24 of the infotainment system 18. The interface 78 can also be displayed on the rear seat display 56. The interface 78 displays a plurality of moods, each of which includes at least one track inspired by the selected mood. FIG. 6 illustrates three moods, although any suitable number of moods can be included. A first window 114 is a relaxed mood. The relaxed mood music can be ambient music inspired by wind chimes. A second window 116 is an upbeat mood. The upbeat mood music can be energetic music intended to create a pumped up feeling. A third window 118 is a nature mood. The nature mood music can be music inspired by the sounds of nature, such as water, birds and forest sounds. Each mood can have one or more tracks associated therewith that can be selected to be played as the background track. The selected mood is preferably displayed in color, and the non-selected moods are preferably shown in black and white to identify the currently selected mood. As shown in FIG. 6, the selected mood music is relaxed, which is the first window 114. The selected relaxed music is music inspired by wind chimes, as shown in the rear seat display 56 of FIG. 5. The first window 114 of FIG. 6 is displayed in color because relaxed mood music is selected. The second and third windows 116 and 118 are shown in black and white because the mood music thereof is not selected.

The interface 78 shown in FIG. 6 can further include a first slide track 120 and a second slide track 122. A first slider 124 is slidable along the first slide track 120 to adjust a distance to vehicle parameter. Adjusting the distance increases or decreases a distance to an objected detectable by the plurality of sensors 16 of the audio system 10. Increasing the distance enables the plurality of sensors 16 to detect objects farther away from the host vehicle 12. Decreasing the stance limits the plurality of sensors 16 to detect objects closer to the host vehicle 12. A second slider 126 is slidable along the second slide track 122 to adjust a field of view parameter. Adjusting the field of view increases or decreases the field of view covered by the plurality of sensors 16. Setting a higher field of view, i.e., to the right in FIG. 6, provides a wider field of view, which includes vehicle behind and to the side of the host vehicle 12. Decreasing the field of view minimizes the field of view to include only objects in front of the host vehicle 12.

The memory 32 stores the plurality of background tracks that can be selected by a user, as shown in FIG. 1. Each of the plurality of notes configured to be assigned to a composer and played during operation of the host vehicle 12 is stored in the memory 32. The electronic controller 14 is configured to play one track of the plurality of tracks continuously through the infotainment system 18 during operation of the host vehicle 12. The one track is the track selected by the user. As shown in FIG. 6, the relaxed mood music inspired by wind chimes is the selected track to be played continuously during operation of the host vehicle 12. The electronic controller 14 is further configured to play one note of the plurality of notes through the infotainment system based on the information detected by the plurality of sensors 16. The one note is played on top of the one track. In other words, the one note corresponds to the detected object determined to be a composer.

The music that is generated on a drive of the host vehicle 12 can be recorded by the memory 32 such that the generated music can be access after the drive. The generated music, i.e., the background track and the notes played based on the detected objects determined to be a composer, stored in the memory 32 is accessible in any conventional manner. A collection of music files are generated over time, which can be linked to memories of road trips or visits to special places. The files can be used as the basis of creative activity outside the car, such as editing and sharing the files through social media. The files generated by the audio system 10 can be shared between host vehicles 12, as shown in FIG. 2.

A game can be played through a display in the host vehicle 12, such as through the rear seat display 56 of FIG. 5 or through a mobile device of a vehicle passenger. A plurality of objects are displayed on the screen based on the detected surroundings of the host vehicle 12, and notes associated with each of the detected objects are played. An additional object is displayed on the screen that is not located in the vicinity of the host vehicle, and a note associated therewith is played. The note played associated with the additional object adds an uncoordinated element to the generated musical soundscape. The player must identify and eliminate the item based on the surrounding view of the host vehicle 12.

Alternatively, the user can use the display, such as the rear seat display 56 of FIG. 5, to indicate which objects should be composers. The display displays the objects in the vicinity of the host vehicle 12 detected by the plurality of sensors 16. The user can select which detected objects shown on the display are composers, and eliminate the detected objects shown on the display that are not deemed to be composers. When the user is provided with a display corresponding to the surroundings of the host vehicle 12 in FIG. 4, the user can select the first vehicle 41 as a composer and indicate that the parked vehicle 52 is not a composer. The user can continue to indicate for each detected object shown on the display whether the detected object is a composer or not a composer. The user can continuously indicate whether objects shown on the display are composers or not composers as new detected objects are shown on the display. Through machine learning, the audio system 10 learns which detected objects are composers and which detected objects are not composers. The feedback provided by the user by selecting or eliminating a detected object as a composer configures the audio system to determine which objects are composers and which objects are not composers by a learned combination of parameters. With a machine learning configuration, manual parameters of the audio system 10 do not need to be set by the user because the machine learning of the audio system facilitates learning of the desired parameters for determination of a composer.

The audio system 10 for the host vehicle 12 plays music based on the surroundings of the host vehicle 12, thereby creating a unique soundscape for each drive. The audio system 10 does not require pre-processing of a map of the travel route, and does not involve actions of the driver, such that a safe system is provided.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the audio system. Accordingly, these terms, as utilized to describe the present invention should be interpreted relative to a vehicle equipped with the audio system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An audio system for a host vehicle, the system comprising:
a plurality of sensors configured to detect information regarding objects in an area surrounding the host vehicle;
an infotainment system including a first speaker and a second speaker; and
an electronic controller configured to play a note through the infotainment system based on the information detected by the plurality of sensors.

2. The system according to claim 1, wherein
the type of note is indicative of a type of object detected.

3. The system according to claim 1, wherein
the infotainment system is configured to play a track continuously during operation of the host vehicle,
the note being played on top of the track.

4. The system according to claim 1, wherein
the first speaker is disposed on a left side of the vehicle, and the second speaker is disposed on a right side of the vehicle.

5. The system according to claim 4, wherein
the information includes a location of a detected object relative to the host vehicle,
the note being played louder in the first speaker or the second speaker based on the location of the detected object.

6. The system according to claim 1, wherein
the information includes a distance of a detected object relative to the host vehicle,
the volume of the note being indicative of the distance to the detected object.

7. The system according to claim 3, wherein
a volume of the track is indicative of a speed of the host vehicle.

8. The system according to claim 1, wherein
the information includes a plurality of parameters, the plurality of parameters including
a position of an object in a visual field of a driver of the host vehicle,
a distance to the object from the host vehicle,
a relative velocity of the object to the host vehicle,
an absolute velocity of the object, and
an amount of time over which the object is detected.

9. The system according to claim 8, wherein
each of the parameters is assigned a weight, the object being detected when a score of the plurality of parameters is larger than a predetermined threshold.

10. The system according to claim 9, wherein
upon determining a plurality of objects, each of the objects is assigned a note to be played indicative of the score.

11. The system according to claim 10, wherein
the note stops being played upon determining that the associated object is no longer detected.

12. An audio system for a host vehicle, the system comprising:
a plurality of sensors configured to detect information regarding objects in an area surrounding the host vehicle;
a memory configured to store a plurality of tracks and a plurality of notes;
an infotainment system including a first speaker and a second speaker; and
an electronic controller configured to play one track of the plurality of tracks continuously through the infotainment system during operation of the host vehicle and configured to play one note of the plurality of notes through the infotainment system based on the information detected by the plurality of sensors, the one note being played on top of the one track.

13. The system according to claim 12, wherein
the type of note is indicative of a type of object detected.

14. The system according to claim 12, wherein
the first speaker is disposed on a left side of the vehicle, and the second speaker is disposed on a right side of the vehicle.

15. The system according to claim 14, wherein
the information includes a location of a detected object relative to the host vehicle,
the note being played louder in the first speaker or the second speaker based on the location of the detected object.

16. The system according to claim 12, wherein
the information includes a distance of a detected object relative to the host vehicle,
the volume of the note being indicative of the distance to the detected object.

17. The system according to claim 12, wherein
a volume of the track is indicative of a speed of the host vehicle.

18. The system according to claim 12, wherein
the information includes a plurality of parameters, the plurality of parameters including
a position of an object in a visual field of a driver of the host vehicle,
a distance to the object from the host vehicle,
a relative velocity of the object to the host vehicle,
an absolute velocity of the object,
an amount of time over which the object is detected, and
a type of object to be detected.

19. The system according to claim 18, wherein
a size of the area is adjustable through a user interface.

20. The system according to claim 12, wherein
the track and each of the plurality of notes played during the operation of the vehicle are stored in the memory.
